(19) United States
(12) Patent Application Publication
(10) Pub. No.: US 2012/0290911 A1
(43) Pub. Date: Nov. 15, 2012

(54) Method for Content Folding

(75) Inventor: Leon Zhao, Guangzhou (CN)

(73) Assignee: TELEFONAKTIEBOLAGET LM ERICSSON (PUBL), Stockholm (SE)

(21) Appl. No.: 13/522,609

(22) PCT Filed: Feb. 4, 2010
(86) PCT No.: PCT/CN2010/000151

§ 371 Date: Jul. 17, 2012

(51) Int. Cl. G06F 17/00; G06F 15/16

(52) U.S. Cl. 715/205; 715/234

(57) ABSTRACT

The present invention relates to content folding of a web page to enable rendering of the web page on a resource-constrained device, and more particularly to interrelated methods, gateway and device for folding, unfolding and rendering of a web page with reduced layout attributes, thus being vertically elongated. Embodiments of the invention analyze the structure and content of the web page and subsequently fold content that carries less information and which would impair the user experience if left unfolded. Other embodiments of the invention unfold previously folded content at an end-users discretion. Embodiments of the invention further offer an integrated pagination solution for folded and unfolded web-pages, and overall customizes the web-page to maximize the user-experience on a device with constrained resources.

### TECHNICAL FIELD

The present invention relates to content folding of a web page to enable rendering of the web page on a resource-constrained device, and more particularly to interrelated methods, gateway and device for folding, unfolding and rendering of a web page with reduced layout attributes.

### BACKGROUND

Content delivered over networks can be feature rich when rendered on the browser of a client, largely due to the rich capabilities built into complex markup languages, such as eXtensible Hypertext Markup Language (XHTML) and Cascading Style Sheets (CSS). XHTML, which is HTML re-cast in XML syntax, is specifically designed for Internet device displays.

CSS is a commonly supported styling language that gives more control over how web pages are displayed. With CSS, style sheets can be created, that define how different elements should appear, such as headers and links. These style sheets can then be applied to any web page. Both XHTML and CSS are described at length in their respective governing specifications provided by the World Wide Web Consortium (W3C). A common computing device, such as a personal computer (PC), executes a browser application to render content that is expressed as CSS-styled XHTML.

While a typical PC has sufficient resources to readily render XHTML+CSS using its browser, a communication device having considerably less memory, processor capacity and/or screen size, and which may be connected over a slow radio link, can experience severe performance degradation in processing and rendering such content.

The Document Object Model (DOM) is a cross-platform and language-independent convention. It defines the logical structure of documents and the way a document is accessed and manipulated. Aspects of the DOM, such as its elements, may be addressed and manipulated within the syntax of the markup language in use. The DOM presents an HTML document as structure—a node tree. The nodes in the node tree have a hierarchical relationship to each other. The top node is called the root. Every node, except the root, has exactly one parent node but all nodes including the root can have any number of children. A leaf is a node with no children. DOM is suited for applications where the document must be accessed repeatedly or out of sequence order. A web browser is not obliged to use DOM in order to render an HTML document. The process of transforming a DOM tree into a markup language is called serialization. One important property of a DOM is structural isomorphism: if two different serializers are used to create a representation of the same document, they Will create the same DOM object. Consequently, an entity of content on a web page can be unambiguously represented by either of two forms, the DOM object or the HTML document. Therefore, it is customary to use the terminology of the DOM to indicate or define also elements and structure of the document itself.

A web gateway is a system providing HTTP Proxy Service to improve the user experience of Internet browsing on a resource-constrained device such as a mobile phone. It maintains a device repository with properties of the resource-constrained device, and uses these properties to restructure large and complex web pages and images to enable rendering by the browser on the device.

The OpenSurf component in Ericsson Drutt Mobile Service Delivery Platform is designed to provide content adaptation features in the web gateway.

Currently mobile operators deploy HTTP Proxy Service in the web gateway and the end-user can use any XHTML-MP compatible browser, embedded or 3rd party software, on a device to surf the Internet. It then operates in a Browser-Server mode.

Some software/service venders such as Opera (http://www.opera.com/mini) and UCWEB (http://www.uc.cn/English/index.shtml) provide Client-Server mode solutions for web content adaptation. Specified client browser software must then be installed on the device.

Since mobile devices usually have a limited screen width compared to a full-fledged PC and the content is delivered as a XHTML-MP page, the layout attributes in CSS are removed. Only XHTML-MP supported CSS attributes remains in the restructured page. Normally the navigation areas of web sites are composed of multiple “div” and “ul”/“li” elements and use CSS to manage the layout. After transforming, the layout CSS attributes are removed and these previously horizontally oriented navigation links will be shown as a long vertical list. While the device screen is limited in width, it is also decidedly limited in height. Therefore, reading the page will require extensive scrolling, and orientation is harder in this new format than in the original format. The used experience is thus inadequate.

### SUMMARY

It is the object to obviate at least some of the above disadvantages and provide improved methods, apparatuses and computer media products avoiding the above mentioned drawbacks.

A first aspect of the invention is an interrelated method in a web gateway for content folding of a web page, which can be represented by a markup language document or the isomorphic DOM tree, enabling rendering of the web page on a resource-constrained device.

The method comprises a step where the web gateway is receiving an HTTP request for a web page from the device over a first network. The gateway is then obtaining the web page from a remote web server. The web page may be in the form of a markup language document, such as an XHTML document comprising extensive layout attributes. After deserializing the web page into a document in a markup language with reduced support for layout attributes, such as XHTML-MP it has principally vertical orientation.

A folding function in the web gateway is identifying the lowest-level folding candidate element of every web page branch. The folding function is then attributing structure attributes to each folding candidate element found during the identification step. The structure attributes are derived from the folding candidate elements children elements, indicative of the amount of content. These steps enable structure recognition and distinction between content suitable for content folding and content that is not suitable for content folding.

Then the folding function in the gateway is replacing each group of consecutive folding candidate element siblings with a replacing folding candidate element, such as e.g. a DIV element, that comprises structure attributes, attributed after the same principles as in the above step. This replacing step recognizes structures that can be compressed or merged together without necessarily also being folded.

The folding function of the gateway is then assessing the structure attributes of each remaining folding candidate element against predetermined criteria for folding elements. This step is distinguishing the information inherent in the content from features that may become a liability when given a principally vertical orientation.

The elements that meet the criteria are then being marked with a unique folding element ID enabling retrieval of the folding element, should the end user wish to unfold a folded element.

Lastly, the folding function of the web gateway is finishing the marked web page by replacing each folding element with a new DIV node comprising a hyperlink generated based on at least the folding element's ID, URL and a bookmark, thus creating a clickable placeholder; and the web gateway is then sending the folded web page to the device.

The identifying step may comprise determining that

none of the element's children is a folding candidate element;

an element is of a predefined type-set;

the average hyperlink text length of the element's children is below a first predefined value; and

the average text length of the element's children is below a second predefined value.

The predefined type-set may comprise the DIV, UL and OL element types. The replacing step may further comprise appending each element of the replaced sibling group as a child to the replacing folding candidate element; and attributing structure attributes to the folding candidate element derived from the folding candidate element's children elements, indicative of the amount of content, such as e.g. attributing structure attributes indicating the length sum of all hyperlink text elements of the children; hyperlink count of the children; length sum of all text elements of the children; text count of the children; and amount of LI elements found in children elements. The text element length may be calculated as word count or alternatively Unicode character count. The below detailed description describes a code analysis procedure for determining which alternative is appropriate.

The first criterion is met when hyperlink count is equal to or above a predetermined value. The second criterion is met when the amount of LI elements in children elements equals zero and the predetermined value is a third predetermined value. The second criterion is met when the amount of LI elements in children elements exceeds zero; and the predetermined value is a fourth predetermined value.

A second aspect of the invention is an interrelated method in a web gateway for unfolding of folded content of a web page, which can be represented by a markup language document or its isomorphic DOM tree, enabling rendering of the web page on a resource-constrained device.

The web gateway is receiving an HTTP request from the device, and is then searching for an unfolding indicator in the request URL. If found, the web gateway is extracting a folding ID and a page URL from the request URL. The element to which the URL points is then being unmarked, i.e. the structure attributes are removed.

Lastly, the folding function of the web gateway is finishing the unfolded web page by replacing each folding element with a new DIV node comprising a hyperlink generated based on at least the folding element's ID, URL and a bookmark; and sending the unfolded web page to the device.

According to the first or second aspect of the invention, the finishing step may further comprise paginating and customizing the web page for the device by chunking it into sub-pages of equal data size, adapted to the device memory and processing capabilities; allocating a page number to each sub-page; sending a pagination navigation bar comprising the allocated page numbers of the web page to the device; receiving a page number from the device; preparing to send the corresponding sub-page as the customized web page. The latter may include appending a bookmark to the URL thereby enabling automatic location of the element on the device screen once it is unfolded.

A third interrelated aspect is an interrelated method in a resource constrained device. This method performs unfolding and rendering of folded content in a web page coded in a markup language with reduced support for layout attributes, such as XHTML-MP, and which has a principally vertical orientation.

The web page is received from a web gateway, and the method comprises sending a HTTP request to a remote web server for a web page via a web gateway. It is not necessary to take into account the kind of markup language the requested web page is written in, and whether it is renderable on the device screen.

The device is then receiving a web page in a folded format optimized for rendering on a limited screen; i.e. a web page upon which the first or second aspect of the invention has been applied.

The device is then rendering the web page and automatically scrolling the content so that the location of the bookmark is visible on the screen.

Upon the end-user clicking a clickable placeholder the third aspect further comprises sending an unfolding request to the web gateway comprising a URL and a folding ID indicating an element associated with the clickable placeholder; and receiving from the web gateway an unfolded web page comprising the unfolded element. The received web page has been unfolded according to the second aspect of the invention.

The method may comprise the further steps receiving a pagination navigation bar comprising page numbers allocated to sub-pages of the unfolded web page to the device. The sub-pages are adapted for the device's limited memory and browser resources. The device is rendering the pagination navigation bar on the screen and upon an end-user selecting a page, the device is sending a request comprising a page number for a corresponding sub-page to the web gateway.

A fourth aspect of the invention is a resource-constrained device comprising a memory, a radio transceiver enabling connectivity to a web gateway over a first network; a processing unit, a user interface comprising a screen. The device is adapted and configured to send a HTTP request to a remote web server via a web gateway, for a web page regardless of format, to receive from the web gateway a web page in a folded format optimized for rendering on a limited screen with limited memory; and to automatically scroll the content so that the location of a bookmark is visible on the screen. The folded format is a result of processing according to a first or a second aspect of the invention.

The device is further adapted and configured to send an unfolding request to the web gateway comprising a URL and a folding ID indicating an element that should be unfolded; to receive from the web gateway the unfolded web page comprising the unfolded element; to receive a pagination navigation bar comprising page numbers allocated to sub-pages of the unfolded web page to the device, the sub-pages being adapted to the device memory; to render the pagination navigation bar on the device; and to send a request comprising a page number for a corresponding sub-page to the web gateway.

A fifth aspect of the invention is a web gateway comprising a first network interface and a transceiver providing connectivity towards a resource constrained device in a first network, a second network interface providing connectivity towards a second network, a memory and a processing unit. The processing unit and the memory together provide a folding function and a folding cache. The web gateway is adapted an configured to receive an HTTP request from the device; to obtain a web page from a remote web server; to identify the lowest-level folding candidate element of every web page branch;

to attribute structure attributes to each folding candidate element derived from its children elements, indicative of the amount of content;

to replace each group of consecutive folding candidate element siblings with a replacing folding candidate element that comprises structure attributes;

to assess the structure attributes of each remaining folding candidate element against predetermined criteria for folding elements; and if the criteria are met

to mark that element with a unique folding element ID enabling retrieval of the folding element, and a bookmark; and

to finish the marked web page by replacing each folding element with a new DIV node comprising a hyperlink generated based on at least the folding element's ID, URL and a bookmark.

The web gateway may further be adapted and configured to customize the web page for the device by chunking it into sub-pages adapted for the device's limited memory and browser resources; to allocate a page number to each sub-page; to send a pagination navigation bar comprising the allocated page numbers of the web page to the device; to receive a page number from the device; and to send the customized web page to the device.

The web gateway may further be adapted to receive an HTTP request from the device; to search for an unfolding indicator in the request URL; and if found to extract a folding ID and a page URL from the request URL; to remove the marking of the folding element to which the page URL points; finish the unfolded web page by replacing each folding element with a new DIV node comprising a hyperlink generated based on at least the folding element's ID, URL and a bookmark; and to send the unfolded web page to the device.

A sixth aspect of the invention is a computer program comprising code means for performing the steps of any one of the aspects 1, 2 or 3 when the program is run on a computer.

A seventh aspect of the invention is a computer program product comprising program code means stored on a computer readable medium for performing the methods of aspects 1, 2 or 3 when said product is run on a computer.

### BRIEF DESCRIPTION OF THE DRAWINGS

FIG. 1 illustrates a system within which a web gateway and a resource-constrained device are interacting.

FIG. 2a and b illustrates schematically a device and a web gateway respectively, according to embodiments of the invention.

FIG. 3 is a flow chart illustrating two interrelated methods according to embodiments of the invention. The methods are performed in a web gateway as depicted in FIG. 2b.

FIG. 4 is a flow chart illustrating an interrelated method in a resource-constrained according to embodiments of the invention.

### DETAILED DESCRIPTION

It is an objective to provide methods, gateway and device for folding of content in a vertically elongated web page, so that it is suitable for rendering in a resource-constrained computing device. A related objective is to reduce the amount of data the device has to send, receive, process, store and render, due to its limited bandwidth, processing and memory capabilities, and user interface, particularly the screen and screen controls.

If is a further objective to preserve the information inherent in the content, while defusing features that may become a liability when given a principally vertical orientation. It is also an objective to achieve the above objectives without offsetting the user experience by procedures that cannot accurately distinguish inherent information from void features. Another important objective is to retain certain dynamics of the original web page to allow the content to remain dynamic in nature.

The below suggested methods, web gateway and device for content folding according to embodiments of the invention, optimizes the use and improves the user experience of a device with constrained resources, which may also receive the content over a relatively slow connection, such as a radio link.

Embodiments of the invention, methods, web gateway and device, are a part of the content adaptation features on the web gateway based on the Mobile Service Delivery Platform OpenSurf. It can be used to support content folding browsing in any device with XHTML-MP rendering capability. It is also a browser independent implementation.

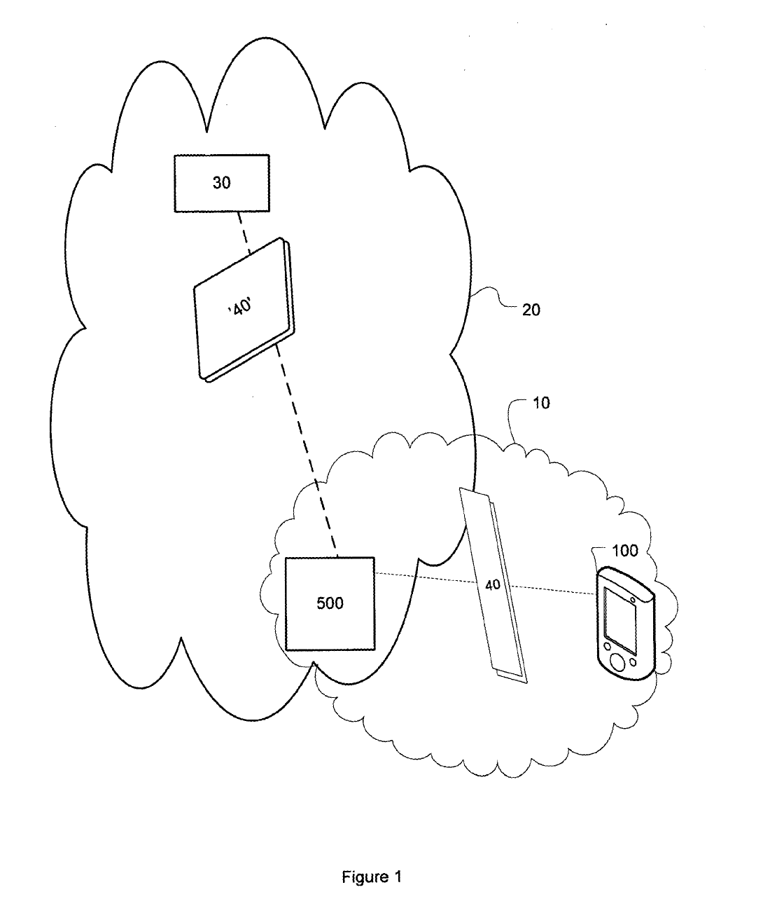

A system in which embodiments of the invention may occur will now be described in relation to FIG. 1. A resource-constrained device 100 may operate in a radio network 10. The device 100 may be a portable radio communication device, and the term device includes but is not limited to all equipment such as mobile telephones, pagers, communicators, electronic organizers, smart phones or the like.

In order to access a web page ‘40’ from a remote web server 30 connected to the Internet 20, the device 100 may connect via a web gateway 500.

When an end user selects a link, the device 100 sends a URL to the web gateway 500, which in turn uses it to request the corresponding web page ‘40’ from the website to which the URL points. Upon reception, the gateway 500 transforms the original web page ‘40’ written in a markup language such as e.g. HTML or XHTML into a web page 40 written in a markup language with reduced support for layout attributes, such as e.g. XHTML-MP. Normally, the navigation areas of web sites are composed of multiple “div” and “ul”/“li” elements and use CSS to manage the layout. After transforming, these previously horizontally oriented navigation links will be shown as a long vertical list. While the device screen is limited in width, it is also decidedly limited in height. Therefore, reading the web page 40 will require extensive scrolling. Furthermore, orientation is harder in this new format than in the original format. The user experience is thus inadequate.

Various Internet web page structures may be used to compose a navigation bar or a hyperlinks list. Common structures for navigation bars are “div+ul+li” and “div+span”. If these structures and patterns can be recognized with an adequately low error rate on discrimination, efficient content folding could be obtained. For example the “div+ul+li” structure may be used both to compose a navigation bar as well as news headlines, and while it is desirable to fold a navigation bar, the news headlines should remain unfolded and fully readable. The primary difference between a navigation bar and a set of news headlines is the length of link texts. Content folding should therefore be based on functions comprising link text length calculation and structure recognition.

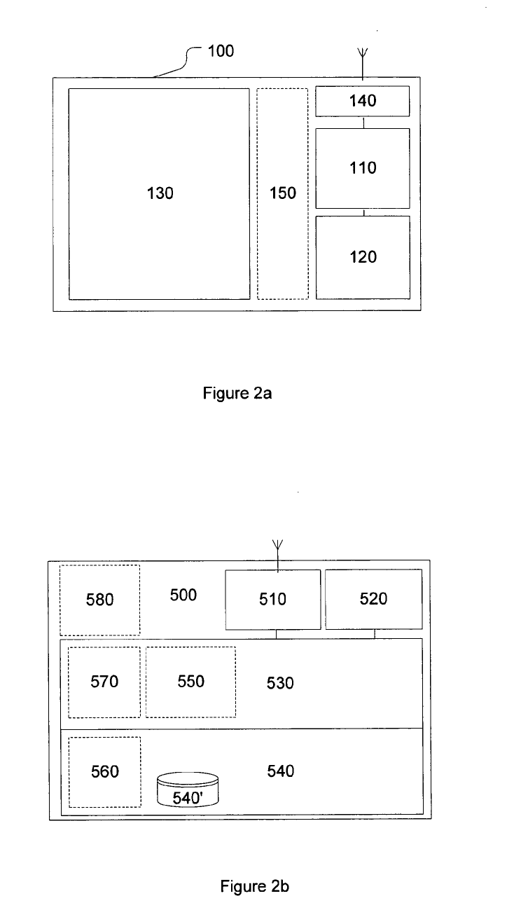

FIG. 2a displays a resource-constrained device 100. It comprises a processor 110 with limited capacity, a memory 120 with limited capacity, a transceiver 140 and a user interface 130. The user interface 130 comprises interfaces that allow the user to interact with the device 100, such as e.g. a key pad, a joy stick or a touch pad. The user interface 130 also comprises a screen with limited dimensions, upon which web pages can be rendered. A browser function 150 is also implemented.

FIG. 2b displays a web gateway 500 comprising a first interface 510 towards a radio network 10 and a second interface 520 towards the Internet 20. The gateway 500 further comprises a processor unit 530 and a memory unit 540. Upon reception of a web page ‘40’, the processor 530 is adapted to transform it to a web page 40 with reduced support for layout attributes. The corresponding markup language document 40 may we written in XHTML-MP. The processor 530 and memory 540 are further adapted and configured to provide a serializing function 550 so that the web page 40 may be interchangeably manipulated as a markup language document 40 and as an isomorphic DOM object 40. The processor 530 and memory 540 further enable a folding function 570 and a folding cache 560, with which the comprised elements of the web page 40 is manipulated either as elements of the document representation 40 or as isomorphic elements of the DOM representation 40.

A person skilled in the art will appreciate that editing of content elements may be achieved by manipulation of a document representation or by an equivalent manipulation of a DOM representation, with the same result. Throughout this patent application, aspects of the DOM, such as e.g. its “elements”, may be non-discriminatingly referenced and described within the syntax of the markup language in use. Analogously, aspects of the markup language documents may be non-discriminatingly referenced and described within the syntax of the corresponding DOM aspect.

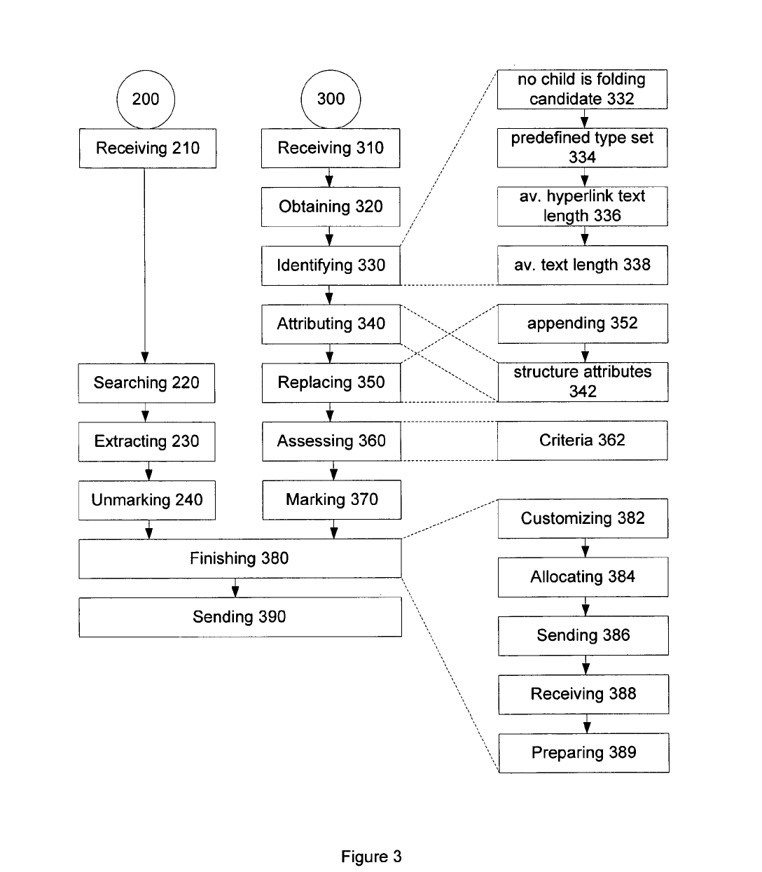

A first interrelated method according to an embodiment of the invention will now be described in relation to FIG. 3. It is a method 300 for content folding performed in a web gateway 500. The content upon which the method 300 is performed is a web page 40, which has been stripped of certain layout attributes. The method 300 is enabling rendering of the web page 40 on a resource-constrained device 100 and it comprises a receiving step 310 where the web gateway 500 is receiving an HTTP request for a web page ‘40’ from the device 100. In an obtaining step 320, the web gateway 500 is obtaining the web page 40 from a remote web server 30.

An identifying step 330 is identifying the lowest-level folding candidate element of every web page 40 branch. This may be done by Depth First Search (DFS), i.e. starting at the root element and visiting as far as possible along each branch before backtracking, and then applying criteria tests 362.

In effect this means recursively determining in step 332 that none of the element's children is a folding candidate element. This is determined based on several criteria.

One criterion is determining in step 334 that an element is of a predefined element type-set. The predefined type set may comprise the DIV element type; it may comprise the UL element type; and it may comprise the OL element type.

Further criteria are determining in step 336 that the average hyperlink text length of the element's children is below a first predefined value; and determining in step 338 that the average text length of the element's children is below a second predefined value.

Average hyperlink text length may be calculated as total hyperlink length, i.e. length sum of all hyperlink text elements, divided by hyperlink count, i.e. the total number of hyperlinks. Average text length may be calculated as total text length, i.e. length sum of all text elements divided by text count, i.e. the total number of texts. Depending on the language in which the texts are written, text element length and hyperlink text element length is being defined differently. For Western languages, it may be defined as number of words. In languages such as Swedish, German or Finnish, where the use of solid compounds, i.e. words with more than one root morpheme, are frequent, these solid compounds may be counted as their number of root morphemes. The German word “verteidigungsminister” would then be counted as two—“verteidigung” and “minister”.

Languages such as Chinese, Vietnamese, Japanese and Korean, henceforth referred to as Eastern languages, use writing systems based on logograms—each character represent a word or a morpheme. For pages written in such languages, Unicode character count may be used.

An attributing step 340 is attributing structure attributes 342 to each folding candidate element. The structure attributes are derived from each folding candidate's children elements, and they are indicative of the structure and amount of content comprised within the folding candidate element, including its children. This step may comprise attributing a structure attribute called “folding”, the presence of which indicates that the element is a folding candidate. No argument is needed for the ‘folding’ attribute at this stage. Further structure attributes may be attributed to the candidate. A structure attribute ‘flinkl’ may be indicating the length sum of all hyperlink text elements of the children, another structure attribute ‘flinks’ may be indicating hyperlink count of the children. A third structure attribute ‘ftextl’ may be indicating the length sum of all text elements of the children. Further, text count of the children; and amount of LI elements found in children elements, may be indicated by structure attributes ‘ftexts’ and ‘fulli’ respectively.

‘flinkrl’, ‘flinks’, ‘ftextl’, ‘ftexts’, and ‘fulli’ assume numerical arguments. An attributed folding element may look like the following example:

<div folding=″″ flinkl=″10″ flinks=″5″ ftextl=″0″ ftexts=″0″ fulli=″1″>...</
div>

Once this primary structure inventory of the web page 40 is made in the web gateway 500, a replacing step 350, comprising replacing each group of consecutive folding candidate element siblings with a replacing folding candidate element that comprises structure attributes is being performed. To each replacing folding candidate element each element of the replaced sibling group is being appended in step 352 as a child. Attributing structure attributes in step 342 to the replacing folding candidate element derived from the folding candidate element's appended children elements is being made to preserve information about the original structure and amount of content. The structure attributes are indicative of the amount of content and are composed as described in the attributing step above. DFS may be used on the DOM object 40 with structure attributes stored on a stack, to find and merge foldable siblings.

The foldable element is wrapped in a context object which also comprises information on children who are sibling foldable elements, and counters for all children, foldable children as well as non-foldable children.

When a foldable element is found, its parent, i.e. the context object of the last foldable element in its ancestor nodes, is being retrieved from the top of the stack.

For each foldable element, the context is pushed into the stack and a recursive visitor is applied on its children.

When all children have been visited, the current element context is being retrieved from the stack in order to determine whether there are groups of consecutive folding candidate siblings. If so, the current element need only be marked with a ‘folding’ attribute and sum of each structure attribute. All folding and structure attributes on children should be removed. A first example structure:

<div folding=″″ flinks=″0″ flinkl=″0″ ftexts=″0″ ftextl=″0″>
<div folding=″″ flinks=″5″ flinkl=″10″ ftexts=″0″ ftextl=″0″>...</div>
<div folding=″″ flinks=″10″ flinkl=″30″ ftexts=″0″ ftextl=″0″>...</div>
</div>

may be merged and transformed into:

<div folding=″″ flinks=″15″ flinkl=″40″ ftexts=″0″ ftextl=″0″>
<div>...</div>
<div>...</div>
</div>

The following example shows two consecutive div elements and one single hyperlink element:

...
<div folding=″″ flinks=″5″ flinkl=″10″ ftexts=″0″ ftextl=″0″>...</div>
<div folding=″″ flinks=″10″ flinkl=″30″ ftexts=″0″ ftextl=″0″>...</div>
<a href=″target.html″>The link text</a>
...

The siblings can be merged and a new div element is appended:

...
<div folding=″″ flinks=″15″ flinkl=″40″
ftexts=″0″ ftextl=″0″>
<div>...</div> .
<div>...</div>
</div>
<a href=″target.html″>The link text</a>
...

The assessing step 360 is assessing the structure attributes of each remaining folding candidate element, i.e. each folding element that has structure attributes, against predetermined criteria for folding elements. The structure attributes used to assess the children elements are presented above, i.e. Total hyperlink length, Hyperlink Count, Total text length, Text Count, Average hyperlink text length and Average text length, and LI Count.

A first criterion for folding is that the number of hyperlinks in an element should be equal to or above a predetermined value. A sub-criterion is that if the amount of LI elements in children elements equals zero (‘fulli’==0), the predetermined value, ‘Flow Links’ should be used. ‘Flow Links’ may be 20 for optimum result. If the amount of LI elements in children elements exceeds zero (‘fulli’>0), the predetermined value ‘Li Links’ should be used. ‘Li Links’ may be 7 for optimum result.

A second criterion is that the average link length of a foldable element is smaller or equal to a predetermined Average Link Length. For Eastern languages this value may be 5 and for Western languages it may be 3.

A third criterion is that the text length of all hyperlinks should be smaller or equal to a predetermined Maximum Link Length. For Eastern languages this value may be 10 and for Western languages it may be 5.

A fourth criterion is that all text lengths of text elements should be smaller than or equal to Maximum Text Length. This value may be 30.

As mentioned the calculation of text and link length is different from Eastern and Western languages. For the Average Link Length, Maximum Link Length and Maximum Text Length thresholds, there should be one for Eastern languages and other for Western languages.

The following algorithm is designed to recognize if Eastern (CJK) languages are used for a web page. Content-Type meta information in the page header is used. If the character set belongs to one of the CJK character set, this page should be using Eastern language thresholds. If Content-Type can not be found or if it uses UTF-8 or Unicode, the language can be found in the attribute of the html element. According to the XHTML spec, the “xml:lang” and “lang” attributes in an html element can be used to determine the language of a page.
If these attributes cannot be found, the first three text contents of the page are used to determine the language. If most or all of them are in an Eastern language the web page is deemed to be using an Eastern language.

If the criteria are met, a marking step 370 is being performed.

The marking step 370 is marking each element for which the criteria are met with a unique folding ID enabling retrieval of the folding element. The folding ID may be added as an argument to the “folding” attribute described above. A bookmark may also be added, which enables easier rendering of the relevant section of the web page 40 on the limited screen of the device 100.

The finishing step 380 is finishing the marked web page 40 by replacing each folding element with a new DIV node comprising a hyperlink generated based on at least the folding element's ID, and URL, thus creating a clickable placeholder. The placeholder requires very little data space, which makes it ideal for devices that receive content over a slow connection such as a radio link, and for devices that have limited memory and processing capabilities. The folding ID may be extracted from the “folding” attribute of the element.

The finishing step (380) may further comprise appending a bookmark to the URL thereby enabling automatic location of the element on the device screen once it is unfolded. An unfolding link is generated, e.g.

requestPath+?e=[foldingid]&*=e[hashValue]&[other request url query
parameters]#dOpSf[foldingId]

The hashValue is generated from the indicator tag “e”, a pre-configured password and the unfolding URL which is used to unfold the element with the respective folding ID. The last part of the unfolding URL is the bookmark for locating the unfolded element. A content digest of the replaced folding element may also be added to the hyperlink.

The DOM object 40 processed by the above method steps will be serialized and stored in the folding cache 560. The Least Recently Used (LRU) algorithm may be used for this cache. The MD5 hash digests of the page URL and the current user's MSISDN may be used as cache key. The cached DOM object 40 is used when the device 100 requests unfolding of a folded element to get full content.

Regardless if the element is eventually folded, all attributes added during the above steps are removed. They are not standard XHTML tag attributes and should not reach the device 100. The structure of the element to be folded, and its children, will look like this:

<div folding=″f1″>
<a name=″dOpSff1″></a>
<ul>...</ul>
<ul>...</ul>
</div>

with folding ID & bookmark in italics.

Currently in HTML and XHTML, adding a bookmark is the most straightforward option for locating a particular position in a page. This is desired for increased user experience. Alternatively, pagination could be made based on the position of unfolded content, so that the unfolded content constitutes the start of a sub-page.

Lastly, the web gateway 500 is sending the folded web page 40 to the device 100.

The Mobile Service Delivery Platform has a global database to store device properties. The web gateway 500 keeps a device repository with information about the device 100, and is paginating content based on the maximum page size that can be processed by the memory and the browser 150 on the device 100. If a large page exceeding this size is sent to the device, the device may lose the page data, it may be unable to render the whole page content or it may simply inform the end user in an error message that “the page is too large”. MSDP OpenSurf already provides pagination functionality. However, since content folding will remove the foldable elements from the web page, the total size of the web page is changed. Therefore pagination must be integrated with content folding and content unfolding methods in order to achieve the intended objective.

The finishing step may therefore comprise the following steps. A customizing step 382 that is customizing the web page 40 for the device 100 by chunking it into sub-pages of that do not exceed the maximum data size that can be rendered. This may be done by traversing the DOM tree 40 and calculating the size of each element and adding to the size of previously traversed elements. Once an amount of elements adapted for the device memory and processing capabilities has been traversed, these traversed elements are being divided into a sub-page. Then traversing continues, so that multiple sub-pages, optimized for that particular device, are being created.

After allocating, in step 384, a page number to each sub-page, a pagination navigation bar is being created and merged with an initial sub-page chosen by default, In a sending step 386 the pagination navigation bar, along with the initial sub-page, is sent to and rendered 640 by the device. The pagination navigation bar is comprising the allocated page numbers of the web page. This enables the end-user to select a page of choice by clicking the pagination navigation bar. The web gateway 500 is subsequently receiving 388 a page number from the device 100.

Upon reception of the page number from the device 100, the web gateway 500 is preparing 389 to send the corresponding sub-page merged with the pagination navigation bar as the customized web page 40 by serializing and returning the chosen sub-page to the device 100 for further rendering on the screen.

An interrelated method 200 will now be described in relation to FIG. 3. It is a method in a web gateway 500 for unfolding of folded content of a web page 40 that has been folded according to the interrelated folding method 300. The web page 40 can be represented by a markup language document 40 or an isomorphic DOM tree 40. The method 200 is enabling rendering of folded elements of the web page 40 on a resource-constrained device 100.

Worth noting is that this unfolding method 200 is not the exact transverse of the folding method 300. A previously folded web page which is subsequently unfolded according to the method 200 may very well still be in a folded format. The method 200 unfolds one of potentially many folded elements of a web page. Notwithstanding, the method 200 enables full retrieval of all items of folded content of the web page. The interrelated method comprises the following steps.

Receiving in a receiving step 210 an HTTP request comprising a request URL from the device 100. In a searching step 220, the web gateway 500 will then be searching for an unfolding indicator “e” in the request URL. The URL may have the following syntax:

requestPath+?e=[foldingId]&*=e[hashValue]&[other query parameters in request url]#dOpSf[foldingId]“e=[foldingId]&*=e[hashValue]” is the indicator.

If the unfolding indicator “e” is found, an extracting step 230 is extracting a folding ID and a page URL from the request URL. The web gateway 500 may be verifying a hashValue before extracting the indicator “e=[foldingId]&*=e”, indicating that an element with a structure attribute “folding=foldingId” should be unfolded.

An unmarking step 240 is unmarking the folding element to which the page URL points. The structure attributes in the unfolded element is being removed in order to disable placeholder transformation, and to enable unfolding.

Content folding is then performed on all foldable elements that become visible due to the unfolding. This is being done according to the content folding method 300 described above.

A finishing step 380 is finishing the unfolded web page 40 by replacing each folding element with a new DIV node comprising a hyperlink generated based on at least the folding element's ID, and URL; and a sending step 390 is sending the unfolded web page 40 to the device 100.

Prior to sending a folded or unfolded web page to the device 100, it is prepared and cached according to the URL and the device 100's MSISDN. If the web gateway 500 is deployed behind the WAP GW, the MSISDN can be sent in the HTTP Request as a header. If the web gateway 500 is directly connected with the GGSN, the MSISDN can be fetched by using request IP address via a Radius Server, which is used for authentication and authorization when a device 100 connects to the GPRS or 3G network. However, since the web gateway 500 is a proxy between the device 100 and the Internet, it may also add the MSISDN to the HTTP request header.

Below follows an example of an unfolding link. The placeholder for the folded content is

<div><a href=″?e=f1&*=ezNE#dOpSff1″>[+]</
a><span>Nyheter&nbsp;Sport&nbsp;Kultur
&amp; Nöje&nbsp;</span></div>

The unfolding link is ?e=f1&*=ezNE#dOpSff1. When the end-user clicks “[+]”, a request with the following URL is sent to WEBGW:

http://www.gp.se/?e=f1&*=ezNE#dOpSff1, where “e=f1” signals the folding ID and *=ezNE is signaling that “e=f1&*=ezNE” is an indicator added by OpenSurf. ‘zNE’ is the hash value calculated from the URL. #DOpSff1′ is the bookmark that is used for locating the position of the unfolded content. When the device browser 150 receives the content, it will automatically scroll the page to where the bookmark: <a name=“dOpSf[foldingId]”></a> is located. Below follows an example of unfolded content:

<div id=″topMenuWrapper″><a name=″dOpSff1″></a>
<ul id=″level1″ class=″row″><Ii id=″navLevel1_iteml″
class=''item start_ department
selected″><strong><a href=″/nyheter″><span>Nyheter
</span></a></strong></Ii><Ii
id=″navLevel1_item2″ class=″item sport_department″><a
href=″/sport″><span>Sport</span></a></Ii><Ii id=
″navLevel1_item3″ class=″item
culture_department″><a href=″/kulturnoje″><span>Kultur
&amp; Nöje</span></a></Ii>

The finishing step may include pagination in the following steps.

A customizing step 382 is customizing the web page 40 for the device 100 by chunking it into sub-pages of a magnitude that do not exceed the maximum data size that can be rendered by the device in terms comprising memory, processor and browser capacity. How this may be done is described above.

After allocating, in step 384, a page number to each sub-page, a pagination navigation bar is being created and merged with an initial sub-page chosen by default, In a sending step 386 the pagination navigation bar, along with the initial sub-page, is sent to and rendered 640 by the device. The pagination navigation bar is comprising the allocated page numbers of the web page. This enables the end-user to select a page of choice by clicking the pagination navigation bar. The web gateway 500 is subsequently receiving 388 a page number from the device 100.

Upon reception of the page number from the device 100, the web gateway 500 is preparing 389 to send the corresponding pub-page merged with the pagination navigation bar as the customized web page 40 by serializing and returning the chosen sub-page to the device 100 for further rendering on the screen. Pagination during unfolding of folded content elements must take into account that the current page number may be changing with the document size changing. It is important to enable the device 100 to scroll the page to the unfolded area. A bookmark enabling this feature may therefore be added for location during the preparing step 389. The bookmark is then sent with the sub-page to the device 100.

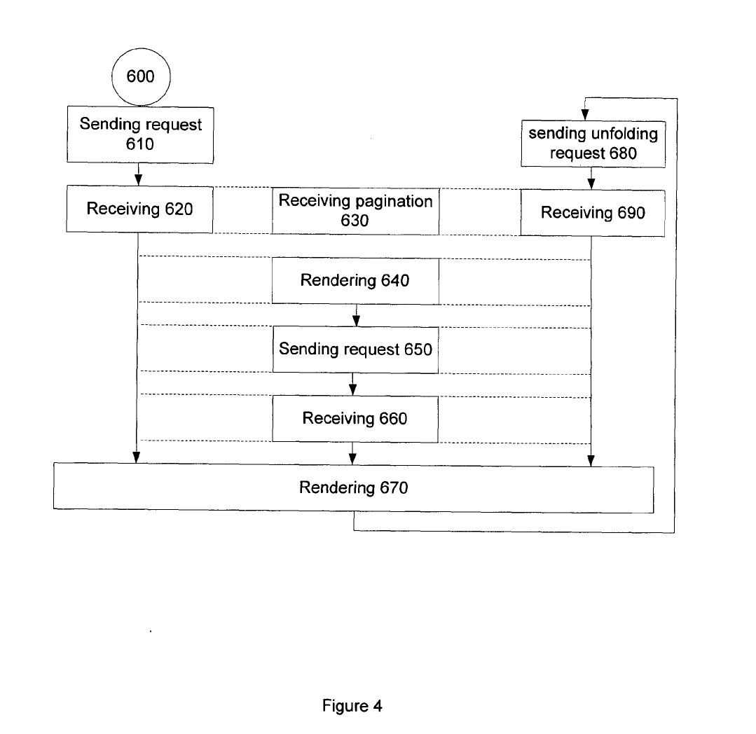

A third interrelated method 600 in a resource-constrained device 100 for unfolding and rendering of folded content in a web page 40 received from a web gateway 500 will now be described in relation to FIG. 4. The third interrelated method 600 comprises the following steps.

A sending step 610 is sending a HTTP request for a web page ‘40’ to a remote web server 30 via a web gateway 500; In is not necessary to take into account the kind of markup language the requested web page is written in, and whether it is renderable on the device screen.

A receiving step 620 is receiving a web page 40, which has a folded format optimized for rendering on a limited screen, and comprising a bookmark. The web page 40 has been folded in the web gateway 500 according to the first interrelated method 300 described above.

A rendering step 670 is rendering the web page 40 and scrolling the content so that the location of the bookmark is visible on the screen.

Upon the end-user selecting an unfoldable link, the device 100 is performing the following steps.

A sending step 680 is sending an unfolding request to the web gateway 500 comprising a URL and a folding ID indicating an element that should be unfolded. An unfolding indicator is also comprised. This step is enabling the web gateway 500 to identify that the request is an unfolding request, and enabling identification of the requested element to be unfolded. The URL may have the following syntax:

requestPath+?e=[foldingid]&*=e[hashValue]&[other query parameters in request url]#dOpSf[foldingid]“e=[foldingId]&*=e[hashValue]” is the indicator.

In a receiving step 690 the device 100 is then receiving from the web gateway 500 an unfolded web page 40 comprising the unfolded element, which is subsequently rendered in a rendering step 670.

The method may comprise the following steps.

A receiving pagination step 630 is receiving a pagination navigation bar comprising page numbers allocated to sub-pages of the unfolded web pate 40 to the device 100, the sub-pages being adapted for the device's (100) limited memory (120) and browser (150) resources. A rendering step 640 is rendering (640) the pagination navigation bar on the device 100 screen, thereby enabling the end-user to select a certain page number. Upon selection of a page, a sending step 650 is sending a request comprising a page number for a corresponding sub-page to the web gateway (500).

Upon receiving the requested unfolded element from the web gateway 500 in a receiving step 660, the browser 150 of the device 100 is rendering the page in a rendering step 670. The device is using the comprised bookmark to scroll to the correct location.

A resource constrained device 100 will now be described in relation to FIG. 2a.

The device 100 comprises a processing unit 110, a memory 120 and a user interface 130 which comprises a screen. Processing unit 110, memory 120 and user interface 130 are constrained resources, which limit user experience, speed and other performance parameters. Further the device 100 comprises a radio transceiver 140 enabling connectivity to a radio network 10 and a web gateway 500 which serves as a gateway between the radio network 10 and the Internet 20, and a processing unit 110. In the device 100 is implemented a browsing function 150. The device 100 is configured and adapted to perform all the steps of the method 600 as described above. It is thus configured and adapted to:

send a HTTP request for a web page ‘40’ to a remote web server 30 via a web gateway 500;

receive from the web gateway 500 a web page 40 in a folded format optimized for rendering on a limited screen with limited memory;

scroll the content so that the location of a bookmark is visible on the screen;

send an unfolding request to the web gateway 500 comprising a URL and a folding ID indicating an element that should be unfolded;

receive from the web gateway 500 the unfolded web page 40 comprising the unfolded element;

receive a pagination navigation bar comprising page numbers allocated to sub-pages of the unfolded web page 40 to the device 100, the sub-pages being adapted to the device memory 120 size; and

send a request comprising a page number for a corresponding sub-page to the web gateway 500.

A web gateway 500 according to an embodiment of the present invention will now be described in relation to FIG. 2b. FIG. 2b displays a web gateway 500 comprising a first interface 510 towards a radio network 10 and a second interface 520 towards the Internet 20. The gateway 500 further comprises a processor 530 and a memory 540. Upon reception of a web page ‘40’, the processor is adapted to transform it to a web page 40 with reduced support for layout attributes. The corresponding markup language document 40 may we written in XHTML-MP. The processor 530 and memory 540 are further adapted and configured to provide a serializing function 550 so that the web page 40 may be interchangeably manipulated as a markup language document 40 and its isomorphic DOM tree 40. A person skilled in the art will appreciate that editing of elements in the web page 40 may be achieved by manipulation of document representation 40 or by equivalent manipulation of the DOM tree representation 40 with the same result. The processor 530 and memory 540, which also comprises a disk-based cache store 540′, further enable a folding function 570 and a folding cache function 560, with which the comprised elements of the web page 40 is manipulated either as elements of the document representation 40 or as isomorphic elements of the DOM representation 40. The web gateway 500 is adapted and configured to perform folding and unfolding according to the first and second aspect of the invention. The web gateway 500 is adapted an configured to

receive an HTTP request for a web page ‘40’ from the device 100 and obtain a web page 40 from a remote web server 30;

identify the lowest-level folding candidate element of every web page 40 branch;

attribute structure attributes to each folding candidate element derived from its children elements, indicative of the amount of content;

replace each group of consecutive folding candidate element siblings with a replacing folding candidate element that comprises structure attributes;

assess the structure attributes of each remaining folding candidate element against predetermined criteria for folding elements, and if the criteria are met;

mark that element with a unique folding element ID enabling retrieval of the folding element, and a bookmark;

finish the marked web page 40 by replacing each folding element with a new DIV node comprising a hyperlink generated based on at least the folding element's ID, and URL; and

customize the web page 40 for the device 100 by chunking it into sub-pages of equal data size, adapted for the device 100 memory and processing capabilities,

allocate a page number to each sub-page,

send a pagination navigation bar comprising the allocated page numbers of the web page to the device 100,

receive a page number from the device 100

send the customized web page 40 to the device 100

The web gateway 500 is further adapted to receive an HTTP request from the device 100 and search for an unfolding indicator in the request URL, and if found:

extract a folding ID and a page URL from the request URL;

remove the marking of the folding element to which the page URL points;

finish the unfolded web page 40 by replacing each folding element with a new DIV node comprising a hyperlink generated based on at least the folding element's ID, and URL; and send the unfolded web page 40 to the device 100.

The combined aspects of the invention give many advantages. Firstly they give a better user experience—the amount of necessary scrolling is reduced. This in turn gives two advantages; the content can be consumed with less user interaction, i.e. it becomes more handy, which is an important aspect not least for user groups with impaired motor activity in their hands, such as elderly or rheumatics. Further, the combined aspects of the invention provide a better overview of the content; firstly because it is all visible on the screen, second of all because the significant information is no longer overshadowed by distracting surplus information. The navigation and orientation in the page is simplified.

The clickable placeholder contains considerably less data than the navigation area which it replaces, and this leads to an accelerated downloading. This is essential for devices that are downloading content over a radio link.

The invention also enables a more efficient use of the device memory and browser capabilities. Pagination customizes sub-pages to fit the device 100. This prevents loss of content, prevents the device from producing error messages informing the end user that the page is too large and it secures rendering of the entire page. The pagination is integrated with the folding and unfolding methods to solve the problem with total size of web pages changing as elements comprised within the pages are folded or unfolded.

The methods according to embodiments of the invention enable distinguishing the navigation areas from normal content in a highly reliable way, thereby significantly reducing the error rate of content folding processing.

The claimed invention is a gateway-based solution and no extra installation of software has to be made on the device. This is an advantage as the device memory and processor capabilities are limited. As for the rest it is also a browser independent implementation.

Embodiments of the invention thus accomplishes the objective to provide methods, gateway and device for folding of content in an original vertically oriented web page, so that it is suitable for rendering in a resource-constrained computing device. The related objective is to reduce the amount of data the device has to send, receive, process, store and render, is achieved through among other things a browser-independent solution, where no extra software installation is necessary on the device. The clickable placeholder comprises considerably less data than the structures it replaces

The objective to preserve the information inherent in the content, while defusing features that may become a liability is achieved through the advanced structure and content analysis upon which aspects of the invention build. Careful experimenting has proven above objectives can be achieved without offsetting the user experience by procedures that cannot accurately distinguish inherent information from void features. Methods according to the invention performs a highly accurate analysis with very low error rate. The objective to retain certain dynamics of the original web page to allow the content to remain dynamic in nature is achieved through the clickable placeholder.

Although particular embodiments of the invention has been illustrated in the accompanying drawings and described in the foregoing detailed description, it will be understood that the invention is not limited to the embodiment disclosed, but allows for rearrangements, modifications and substitutions without departing from the spirit of the invention as set forth and defined by the following claims.

1-22. (canceled)

23. A method in a web gateway for content folding of a web page, which can be represented by one of a markup language document and its isomorphic DOM tree, enabling rendering of the web page on a resource-constrained device, the method comprising:
receiving an HTTP request for a web page from the device;
obtaining the web page from a remote web server;
identifying a lowest-level folding candidate element of the web page branches;
attributing structure attributes to each folding candidate element derived from its children elements, indicative of the amount of content;
replacing each group of consecutive folding candidate element siblings with a replacing folding candidate element that comprises structure attributes;
assessing the structure attributes of each remaining folding candidate element against predetermined criteria for folding candidate elements, and if the criteria are met, marking that element with a unique folding element ID enabling retrieval of the folding candidate element;
finishing the marked web page by replacing each folding element with a new DIV node comprising a hyperlink generated based on at least the folding candidate element's ID, and URL, thus creating a clickable placeholder; and
sending the folded web page to the device.

24. The method of claim 23, wherein identifying the lowest-level folding candidate element of the web page branches further comprises:
determining that none of the element's children is a folding candidate element;
determining that an element is of a predefined type-set;
determining that the average hyperlink text length of the element's children is below a first predefined value; and
determining that the average text length of the element's children is below a second predefined value.

25. The method of claim 24, wherein the predefined type-set comprises DIV, UL and OL element types.

26. The method of claim 23, wherein replacing each group of consecutive folding candidate element siblings with the replacing folding candidate element that comprises structure attributes further comprises:
appending each element of the replaced sibling group as a child to the replacing folding candidate element; and
attributing structure attributes to the folding candidate element derived from the folding candidate element's children elements, indicative of the amount of content.

27. The method according to claim 23, wherein attributing structure attributes to each folding candidate element derived from its children elements, indicative of the amount of content, further comprises:
attributing structure attributes indicating the length sum of all hyperlink text elements of the children;
a hyperlink count of the children;
a length sum of all text elements of the children;
a text count of the children; and
an amount of LI elements found in children elements.

28. The method of claim 26, where the replacing folding candidate element is a DIV node.

29. The method of claim 24, wherein the text element length is calculated as word count.

30. The method of claim 24, wherein the text element length is calculated as Unicode character count.

31. The method of claim 23, wherein a first criterion is met when a hyperlink count is equal to or above a predetermined value.

32. The method of claim 31, wherein a second criterion is met when the amount of LI elements in the children elements equals zero and the predetermined value is a third predetermined value.

33. The method of claim 31, wherein a second criterion is met when the amount of LI elements in children elements exceeds zero; and the predetermined value is a fourth predetermined value.

34. The method according to claim 23, wherein finishing the marked web page by replacing each folding element with the new DIV node comprising the hyperlink generated based on at least the folding candidate element's ID, and URL, thus creating a clickable placeholder further comprises:
appending a bookmark to the URL thereby enabling automatic location of the element on the device screen once it is unfolded.

35. The method according to claim 23, wherein finishing the marked web page by replacing each folding element with the new DIV node comprising the hyperlink generated based on at least the folding candidate element's ID, and URL, thus creating a clickable placeholder further comprises:
customizing the web page for the device by chunking it into sub-pages of equal data size, adapted to the device memory and processing capabilities;
allocating a page number to each sub-page;
sending a pagination navigation bar comprising the allocated page numbers of the web page to the device;
receiving a page number from the device; and
preparing to send the corresponding sub-page as the customized web page.

36. A method in a web gateway for unfolding of folded content of a web page, which can be represented by one of a markup language document and an isomorphic DOM tree, enabling rendering of the web page on a resource-constrained device, the method comprising:
receiving an HTTP request from the device;
searching for an unfolding indicator in the request URL; and if found:
extracting a folding ID and a page URL from the request URL;
unmarking a folding element to which the page URL points;
finishing the unfolded web page by replacing each folding element with a new DIV node comprising a hyperlink generated based on at least the folding element's ID, and URL; and
sending the unfolded web page to the device.

37. The method according to claim 36, wherein finishing the unfolded web page by replacing each folding element with the new DIV node comprising the hyperlink generated based on at least the folding element's ID, and URL further comprises:
appending a bookmark to the URL thereby enabling automatic location of the element on the device screen once it is unfolded.

38. The method according to claim 36, wherein finishing the unfolded web page by replacing each folding element with the new DIV node comprising the hyperlink generated based on at least the folding element's ID, and URL further comprises:
customizing the web page for the device by chunking it into sub-pages of equal data size, adapted to the device memory and processing capabilities;
allocating a page number to each sub-page;
sending a pagination navigation bar comprising the allocated page numbers of the web page to the device;
receiving a page number from the device; and
preparing to send the corresponding sub-page as the customized web page (40).

39. A method in a resource constrained device for unfolding and rendering of folded content in a web page received from a web gateway, the method comprising:
sending a HTTP request to a remote web server via a web gateway;
receiving a web page in a folded format optimized for rendering on a limited screen; and
rendering the web page and scrolling the content so that the location of the bookmark is visible on the screen.

40. The method of claim 39, further comprising upon receiving a signal from an end-user clicking a clickable placeholder:
sending an unfolding request to the web gateway comprising a URL and a folding ID indicating an element associated with the clickable placeholder; and
receiving from the web gateway an unfolded web page comprising the unfolded element.

41. The method of claim 39, further comprising:
receiving a pagination navigation bar comprising page numbers allocated to sub-pages of the unfolded web page to the device, the sub-pages being adapted for the device's limited memory and browser resources;
rendering the pagination navigation bar on the device; and
upon a user selecting a page, sending a request comprising a page number for a corresponding sub-page to the web gateway.

42. A resource constrained device comprising a memory, a radio transceiver enabling connectivity to a web gateway over a network, a processing unit, a user interface comprising a screen, the device being configured to:
send a HTTP request to a remote web server via a web gateway;
receive from the web gateway a web page in a folded format optimized for rendering on a limited screen with limited memory;
scroll the content so that the location of a bookmark is visible on the screen;
send an unfolding request to the web gateway comprising a URL and a folding ID indicating an element that should be unfolded;
receive from the web gateway the unfolded web page comprising the unfolded element;
receive a pagination navigation bar comprising page numbers allocated to sub-pages of the unfolded web page to the device, the sub-pages being adapted to the device memory;
render the pagination navigation bar on the device; and
send a request comprising a page number for a corresponding sub-page to the web gateway.

43. A web gateway comprising a first network interface and a transceiver providing connectivity towards a resource constrained device in a radio network, a second network interface providing connectivity towards the Internet, a memory and a processing unit, the web gateway configured to:
receive an HTTP request from the device;
obtain a web page from a remote web server;
identify the lowest-level folding candidate element of every web page branch;
attribute structure attributes to each folding candidate element derived from its children elements, indicative of the amount of content;
replace each group of consecutive folding candidate element siblings with a replacing folding candidate element that comprises structure attributes;
assess the structure attributes of each remaining folding candidate element against predetermined criteria for folding elements; and if the criteria are met mark that element with a unique folding element ID enabling retrieval of the folding element, and a bookmark;
finish the marked web page by replacing each folding element with a new DIV node comprising a hyperlink generated based on at least the folding element's ID, URL and a bookmark;
customize the web page for the device by chunking it into sub-pages adapted for the device's limited memory and browser resources;
allocate a page number to each sub-page;
send a pagination navigation bar comprising the allocated page numbers of the unfolded web page to the device;
receive a page number from the device; and
send the customized web page to the device.

44. The web gateway of claim 43, wherein the web gateway is further configured to:
receive an HTTP request from the device;
search for an unfolding indicator in the request URL, and if found, extract a folding ID and a page URL from the request URL;
remove the marking of the folding element to which the page URL points;
finish the unfolded web page by replacing each folding element with a new DIV node comprising a hyperlink generated based on at least the folding element's ID, URL and a bookmark; and
send the unfolded web page to the device.

45. A computer program product stored in a non-transitory computer readable medium for controlling a web gateway for content folding of a web page, which can be represented by one of a markup language document and its isomorphic DOM tree, enabling rendering of the web page on a resource-constrained device, the computer program product comprising software instructions which, when run on the web gateway, causes the web gateway to:
receive an HTTP request for a web page from the device;
obtain the web page from a remote web server;
identify a lowest-level folding candidate element of the web page branches;
attribute structure attributes to each folding candidate element derived from its children elements, indicative of the amount of content;
replace each group of consecutive folding candidate element siblings with a replacing folding candidate element that comprises structure attributes;
assess the structure attributes of each remaining folding candidate element against predetermined criteria for folding candidate elements, and if the criteria are met, marking that element with a unique folding element ID enabling retrieval of the folding candidate element;
finish the marked web page by replacing each folding element with a new DIV node comprising a hyperlink generated based on at least the folding candidate element's ID, and URL, thus creating a clickable placeholder; and
send the folded web page to the device.

46. A computer program product stored in a non-transitory computer readable medium for controlling a web gateway for unfolding of folded content of a web page, which can be represented by one of a markup language document and an isomorphic DOM tree, enabling rendering of the web page on a resource-constrained device, the computer program product comprising software instructions which, when run on the web gateway, causes the web gateway to:
receive an HTTP request from the device;
search for an unfolding indicator in the request URL; and if found:
extract a folding ID and a page URL from the request URL;
unmark a folding element to which the page URL points;
finish the unfolded web page by replacing each folding element with a new DIV node comprising a hyperlink generated based on at least the folding element's ID, and URL; and
send the unfolded web page to the device.

47. A computer program product stored in a non-transitory computer readable medium for controlling a resource constrained device for unfolding and rendering of folded content in a web page received from a web gateway, the computer program product comprising software instructions which, when run on the device, causes the device to:
send a HTTP request to a remote web server via a web gateway;
receive a web page in a folded format optimized for rendering on a limited screen; and
render the web page and scrolling the content so that the location of the bookmark is visible on the screen.

48. A computer program product stored in a non-transitory computer readable medium for controlling a resource constrained device comprising a memory, a radio transceiver enabling connectivity to a web gateway over a network, a processing unit, a user interface comprising a screen, the computer program product comprising software instructions which, when run on the device, causes the device to:
send a HTTP request to a remote web server via a web gateway;
receive from the web gateway a web page in a folded format optimized for rendering on a limited screen with limited memory;
scroll the content so that the location of a bookmark is visible on the screen;
send an unfolding request to the web gateway comprising a URL and a folding ID indicating an element that should be unfolded;
receive from the web gateway the unfolded web page comprising the unfolded element;
receive a pagination navigation bar comprising page numbers allocated to sub-pages of the unfolded web page to the device, the sub-pages being adapted to the device memory;
render the pagination navigation bar on the device; and
send a request comprising a page number for a corresponding sub-page to the web gateway.

49. A computer program product stored in a non-transitory computer readable medium for controlling a web gateway comprising a first network interface and a transceiver providing connectivity towards a resource constrained device in a radio network, a second network interface providing connectivity towards the Internet, a memory and a processing unit, the computer program product comprising software instructions which, when run on the web gateway, causes the web gateway to:
receive an HTTP request from the device;
obtain a web page from a remote web server;
identify the lowest-level folding candidate element of every web page branch;
attribute structure attributes to each folding candidate element derived from its children elements, indicative of the amount of content;
replace each group of consecutive folding candidate element siblings with a replacing folding candidate element that comprises structure attributes;
assess the structure attributes of each remaining folding candidate element against predetermined criteria for folding elements; and if the criteria are met mark that element with a unique folding element ID enabling retrieval of the folding element, and a bookmark;
finish the marked web page by replacing each folding element with a new DIV node comprising a hyperlink generated based on at least the folding element's ID, URL and a bookmark;
customize the web page for the device by chunking it into sub-pages adapted for the device's limited memory and browser resources;
allocate a page number to each sub-page;
send a pagination navigation bar comprising the allocated page numbers of the unfolded web page to the device;
receive a page number from the device; and
send the customized web page to the device.
